(19) United States
(12) Patent Application Publication
(10) Pub. No.: US 2016/0078608 A1
(43) Pub. Date: Mar. 17, 2016

(54) RETICLE INSPECTION APPARATUS AND METHOD

(71) Applicant: SAMSUNG ELECTRONICS CO., LTD., Suwon-si (KR)

(72) Inventors: Ji-Hoon NA, Bucheon-si (KR); Byung-Gook KIM, Seoul (KR); Hyuk-Joo KWON, Seongnam-si (KR)

(21) Appl. No.: 14/692,128

(22) Filed: Apr. 21, 2015

(30) Foreign Application Priority Data
Sep. 12, 2014 (KR) 10-2014-0121115

(51) Int. Cl. G06T 7/00

(52) U.S. Cl. CPC G06T 7/001; G06T 7/0008; G06T 2207/30148

(57) ABSTRACT

A reticle inspection apparatus includes a reticle, an image generator to generate images of a surface of the reticle, and an image processor to compare first and second images generated by the image generator. The first image is generated when a pellicle is not on the reticle and the second image is generated when the pellicle is on the reticle.

### CROSS-REFERENCE TO RELATED APPLICATION

Korean Patent Application No. 10-2014-0121115, filed on Sep. 12, 2014, and entitled, “Reticle Inspection Apparatus and Method,” is incorporated by reference herein in its entirety.

### BACKGROUND

1. Field

One or more embodiments described herein relate to a reticle inspection apparatus and method.

2. Description of the Related Art

Circuit patterns have become finer due to high integration of semiconductor devices. The formation of fine circuit patterns may be performed by managing various parameters. For example, a photolithography process may affect formation of fine circuit patterns.

When forming a circuit pattern on a wafer using a photolithography process, a photoresist may be coated on the wafer. Then, the coated photoresist is exposed to light to transfer a circuit pattern formed on a reticle. The exposure is performed by projecting light of a predetermined wavelength onto the reticle. Transmitted or reflected light is then irradiated on the wafer coated with the photoresist to form a pattern. The exposed photoresist is then developed. Thus, a series of processes are performed in order to form the circuit pattern.

However, when particles or scratches occur on a pellicle that protects the reticle or near, adjacent, or on the reticle, process efficiency may decrease. This may, in turn, deteriorate the reliability of the semiconductor devices.

### SUMMARY

In accordance with one or more embodiments, a reticle inspection apparatus includes a reticle; an image generator to generate images of a surface of the reticle; and an image processor to compare first and second images generated by the image generator, wherein the first image is to be generated when a pellicle is not on the reticle and the second image is to be generated when the pellicle is on the reticle. The apparatus may include a storage area to store one or more of the first or second images. The storage area may store the first and second images and is to output the first and second images to the image processor.

Each of the first and second images may include first to n-th frame regions, where n is a natural number equal to or greater than 2. The image processor may compare images of corresponding ones of the frame regions of the first and second images. The image processor may compare brightness values of the images of corresponding ones of the frame regions in the first and second images.

The image processor may compare a first signal detected from the first image and a second signal detected from the second image. The first signal may be indicative of a brightness of at least one frame region of the first image, and the second signal maybe indicative of a brightness of at least one frame region of the second image. When a difference value between the first signal and the second signal is equal to or greater than a predetermined difference value, the image processor is to determine existence of a defect on the pellicle or near, adjacent, or on the reticle.

In accordance with one or more other embodiments, a reticle inspection apparatus includes a reticle; a pellicle on the reticle to transmit extreme ultraviolet (EUV) light; an image generator to generate first and second images of a surface of the reticle; a storage area to store the first and second images; and an image processor to compare the first and second images, wherein the first image is to be generated when the pellicle is not on the reticle and the second image is to be generated when the pellicle is on the reticle.

Each of the first and second images may include first to n-th frame regions, where n is a natural number equal to or greater than 2. The image processor may compare images of corresponding ones of the frame regions in the first and second images. The image processor may compare a first signal detected from the first image and a second signal detected from the second image. The first signal may be indicative of a brightness of at least one frame region of the first image, and the second signal may be indicative of a brightness of at least one frame region of the second image. When a difference value between the first signal and the second signal is equal to or greater than a predetermined difference value, the image processor may determine the existence of a defect on the pellicle or near, adjacent, or on the reticle.

In accordance with one or more other embodiments, an apparatus includes an interface coupled to an image generator; and logic coupled to the interface to determine existence of a defect on a pellicle or near, adjacent, or on the reticle based on a first signal and a second signal, the first signal corresponding to a first image and the second signal corresponding to a second image, the first image to be generated when the pellicle is not on the reticle and the second image to be generated when the pellicle is on the reticle. The first signal may be indicative of a brightness of the first image, and the second signal may be indicative of a brightness of the second image.

The first signal may be indicative of the brightness of one or more partial regions of the first image, and the second signal may be indicative of the brightness of one or more partial regions of the second image. The logic may compare the first signal and the second signal, and determine existence of the defect based on a result of the comparison. The logic may determine existence of the defect when a difference value between the first signal and the second signal is equal to or greater than a predetermined difference value.

### BRIEF DESCRIPTION OF THE DRAWINGS

Features will become apparent to those of skill in the art by describing in detail exemplary embodiments with reference to the attached drawings in which:

FIG. 1 illustrates an example of transmittance of a pellicle based on wavelength;

FIG. 2 illustrates an embodiment of a reticle inspection apparatus;

FIG. 3 illustrates a block diagram of the reticle inspection apparatus;

FIG. 4 illustrates an example of frames of a first image;

FIG. 5 illustrates an example of frames of a second image;

FIG. 6 illustrates an example of a defect signal;

FIG. 7 illustrates another embodiment of a reticle inspection apparatus;

FIG. 8 illustrates another embodiment of a reticle inspection apparatus;

FIG. 9 illustrates an embodiment of a reticle inspection method;

FIG. 10 illustrates another embodiment of a reticle inspection method;

FIG. 11 illustrates an embodiment of an electronic system; and

FIGS. 12 and 13 illustrate embodiments of semiconductor systems.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout.

It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

The present invention will be described with reference to perspective views, cross-sectional views, and/or plan views, in which preferred embodiments of the invention are shown. Thus, the profile of an exemplary view may be modified according to manufacturing techniques and/or allowances. That is, the embodiments of the invention are not intended to limit the scope of the present invention but cover all changes and modifications that can be caused due to a change in manufacturing process. Thus, regions shown in the drawings are illustrated in schematic form and the shapes of the regions are presented simply by way of illustration and not as a limitation.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

In accordance with one or more embodiments, a reticle inspection apparatus and method may be used in a semiconductor manufacturing process in which, for example, a lithography process is performed using extreme ultraviolet (EUV) light. In one embodiment, the method detects defects on a pellicle, or near, adjacent, or on the reticle, by comparing scan images before and after the pellicle is mounted on the reticle, for example, using an optical microscope. Thus, it is possible to improve process efficiency by compensating difficulties in developing an expensive actinic inspection apparatus. It is also possible to provide an inspection apparatus with high efficiency at low cost.

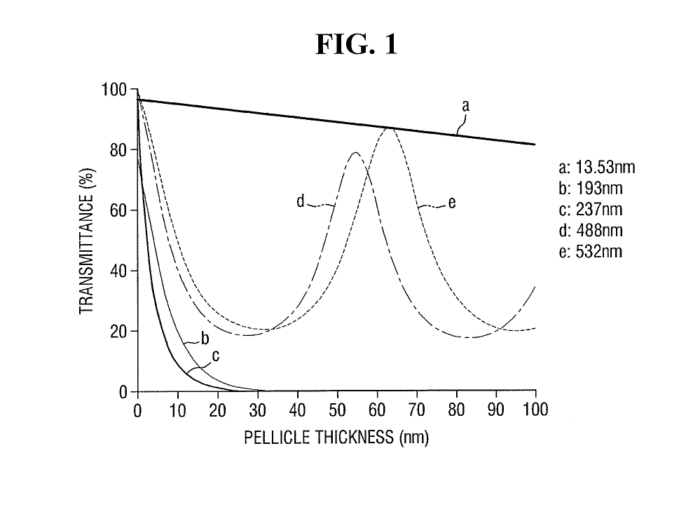

FIG. 1 is a graph illustrating an example of transmittance of a pellicle within a range of wavelengths, which, for example, may include different kinds of light. Referring to FIG. 1, first light a is EUV light having a wavelength of 13.53 nm and a pellicle transmittance which decreases linearly as the thickness of the pellicle increases.

The EUV light (e.g., light having a wavelength of 13.53 nm) may be used in a lithography process. Accordingly, a reticle inspection apparatus may be developed which also uses light having the wavelength of the EUV light, namely 13.53 nm. However, this approach tends to be expensive.

The graph of FIG. 1 also includes second light b which is ArF light having a wavelength of 193 nm, third light c which is KrF light having a wavelength of 257 nm, fourth light d which is Ar light having a wavelength of 488 nm, and fifth light e which is Nd:YAG light having a wavelength of 532 nm. In the cases of second light b to fourth light d, it is difficult to obtain performance of the pellicle transmittance of first light a having a wavelength of 13.53 nm. A reticle inspection apparatus may be developed using Nd:YAG light that is fifth light e, but development of such an apparatus is expensive.

The pellicle may be mounted on the reticle to protect the reticle during the lithography process. When the pellicle is mounted in this manner, particles or other defects may form on the pellicle, or near, adjacent, or on the reticle, which may have an adverse affect on projection of the pattern formed on the reticle. The defects may include, for example, scratches, particles, aberrations, or other forms of deformation on the pellicle, or near, adjacent, or on the reticle, that may affect the pattern to be projected. These may reduce the reliability of the final semiconductor product. In accordance with one or more embodiments, the reticle on which the pellicle is mounted may be inspected. In one embodiment, the one or more parameters (e.g., pellicle thickness, etc.) controlling the pellicle transmittance may be based on the wavelength of light to be used in the photolithography process, which, for example, may correspond to any of the curves or wavelengths in FIG. 1.

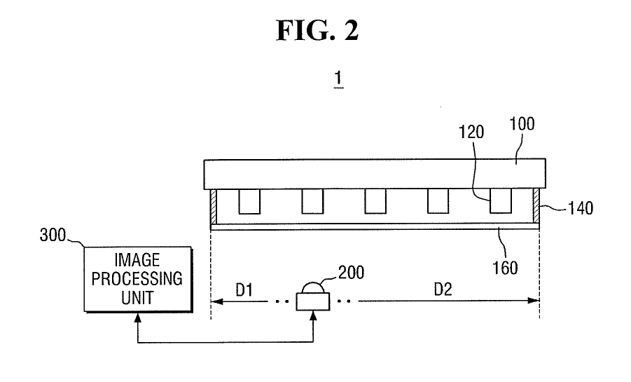

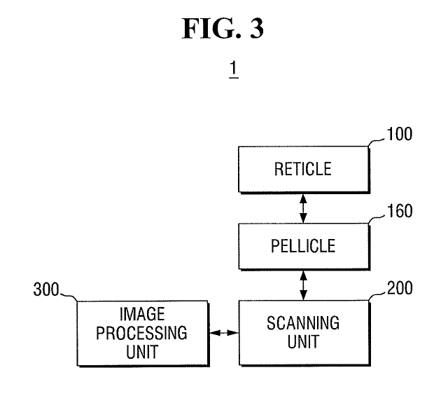

FIG. 2 illustrates an embodiment of a reticle inspection apparatus 1. FIG. 3 illustrates a block diagram embodiment of the reticle inspection apparatus 1. Referring to FIGS. 2 and 3, the reticle inspection apparatus 1 includes a reticle 100, a pellicle 160, a scan image generating unit 200, and an image processing unit 300.

The reticle 100 may include a transparent area and an opaque area to define a pattern 120 to be transferred to a photoresist coated on the surface of a semiconductor substrate. Light may be passed through the reticle 100 via a projection optical system and irradiated on the semiconductor substrate. In this case, a photoresist material may be coated on the semiconductor substrate. The photoresist material may be divided into a negative photoresist material and a positive photoresist material.

If the negative photoresist material is coated on the semiconductor substrate, a portion exposed to light may be cured and a portion not exposed to light may be removed in a developing process. When using the negative photoresist material, a pattern opposite to the pattern 120 of the reticle 100 may form on the semiconductor substrate.

In accordance with one embodiment, a light source providing light in a predetermined wavelength range is transmitted through the reticle. The predetermined wavelength range may correspond, for example, to EUV light. When the light is in the EUV range and the photolithography process uses EUV light, the efficiency of the reticle inspection apparatus 1 may be increased or maximized. In another embodiment, the reticle inspection apparatus 1 may be used in a lithography process that uses DUV wavelength light.

In other embodiments, the reticle inspection apparatus 1 may be used in a process that uses light having a wavelength of g-line (436 nm), i-line (365 nm), KrF (248 nm) and ArF (193 nm). In one embodiment, the reticle inspection apparatus 1 may be used in a process that uses various next-generation lithography (NGL) technologies, e.g., directed self-assembly (DSA), X-ray lithography, nano imprint lithography (NIL) and E-beam lithography. In another embodiment, the predetermined wavelength range may be a different range from the examples discussed above.

The pellicle 160 is a protective film that is placed over (e.g., sticks to) the surface of the pattern of the reticle 100 in order to prevent contamination of the pattern 120 on the reticle 100, e.g., to prevent foreign substances from being adhered to the reticle 100. A pellicle support 140 may support the pellicle 160. The pellicle support 140 may be formed on the reticle 100, and the pellicle 160 may be attached to the pellicle support 140. Further, the pellicle 160 may be attached to one surface of the reticle 100 (e.g., the surface on which the pattern 120 is formed) using a predetermined adhesive.

If the pellicle 160 is attached to the surface of the reticle 100 or is attached to the pellicle support 140, particles may collect on the pattern 120 formed on the surface of the reticle 100. Particularly, if particles collect on or adjacent to the pattern 120, then, when exposure is performed using the reticle 100 in a subsequent process, the pattern transferred onto the semiconductor substrate may be distorted.

If the pattern 120 is not accurately transferred onto the semiconductor substrate, additional processing cost may incurred and reliability of the final semiconductor product may be reduced. In order to avoid this problem, in accordance with one embodiment, the reticle inspection apparatus 1 for performing an inspection is provided on the reticle 100 on which the pellicle 160 is attached.

The scan image generating unit 200 generates a scan image of the surface of the reticle 100. The scan image generating unit 200 may include, for example, an optical microscope or a confocal microscope. When a confocal microscope is used, it is possible to improve resolution of the generated scan image by blocking light reflected from the pellicle 160.

For example, the scan image generating unit 200 may generate a scan image by laser scanning. The scan image generating unit 200 includes a light source for emitting light of a particular wavelength, and a laser diode (LD) may be used as the light source of the scan image generating unit 200. In another embodiment, a different device may be used (e.g., one emitting monochromatic light) in place of the LD.

The scan image generating unit 200 generates a first image I1 and a second image I2. The first image I1 is a scanned image in a state where the pellicle 160 is not fixed to the reticle 100. The second image I2 is a scanned image in a state where the pellicle 160 is fixed to the reticle 100.

The scan image generating unit 200 may generate scan images by scanning the entire surface of the reticle 100 when generating the first image I1 and the second image I2. However, it is also possible to generate the first image I1 and the second image I2 by scanning only the area where the pattern 120 is formed on the reticle 100.

The image processing unit 300 compares the first image I1 and the second image I2 provided from the scan image generating unit 200. The image processing unit 300 may calculate a difference between two images by comparing the first image I1 and the second image I2. If a signal equal to or greater than a predetermined value is detected from the difference between the images, the signal may indicate that a defect (e.g., particle) exists on the pellicle 160 or near, adjacent, or on the reticle 100.

For example, the image processing unit 300 may determine the existence of a defect (e.g., particle) by comparing a first signal S1 detected from the first image I1 and a second signal S2 detected from the second image I2. Each of the first signal S1 and the second signal S2 may be a signal indicative of the brightness value of the image. By measuring the first signal S1 detected according to the brightness value of the image with respect to the entire surface of the first image I1, and measuring the second signal S2 detected according to the brightness value of the image with respect to the entire surface of the second image I2, it is possible to calculate a difference between the first signal S1 and the second signal S2.

If the difference between the first signal S1 and the second signal S2 is equal to or greater than a predetermined difference value, the image processing unit 300 may determine that a defect (e.g., particle, scratch, etc.) exists on the pellicle 160 attached to the reticle 100 or near, adjacent, or on the reticle 100. When such a defect is determined to exist, the pellicle 160 may be clean and put back on the reticle or replaced with a new pellicle, or the defect may otherwise be corrected or removed or the reticle 100 replaced, e.g., when the defect is near, adjacent, or on the reticle 100.

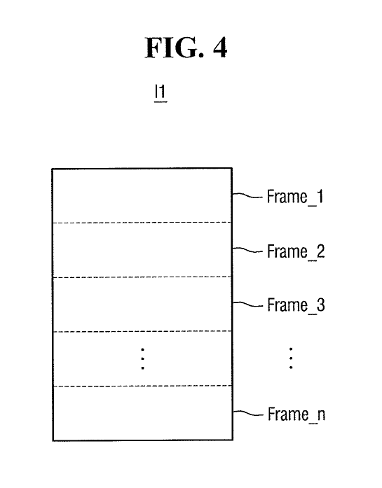

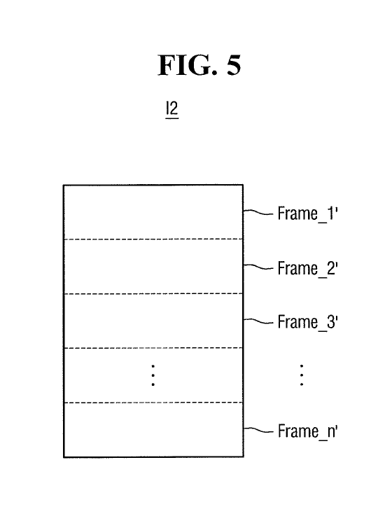

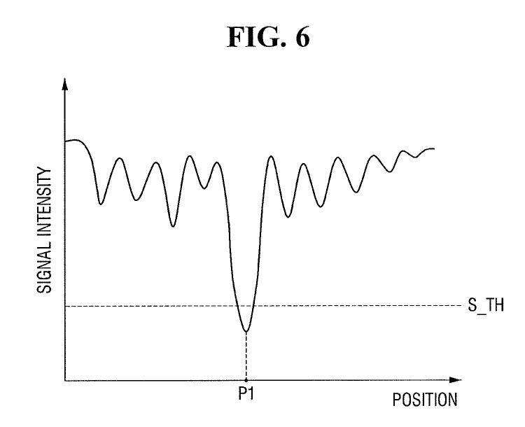

FIG. 4 illustrates an example of frames of the first image. FIG. 5 illustrates an example of frames of the second image. FIG. 6 illustrates an example of a defect signal due to a defect. Referring to FIGS. 4 and 5, the first image I1 may include first to n-th frame regions Frame_1, Frame_2, Frame_3, . . . , Frame_n, and the second image I2 may include first to n-th frame regions Frame_1′, Frame_2′, Frame_3′, . . . , Frame_n′.

FIGS. 4 and 5 illustrate a case where n is 4, but the images may include a different number of frame regions in another embodiment. For example, n may be a natural number equal to or greater than 2. The number of frame regions may be set differently, for example, depending on the application. In one embodiment, the first and second images may include different numbers of frame regions.

The image processing unit 300 may detect defects (e.g., particles) on the pellicle, or near, adjacent, or on the reticle 100, by comparing the images of the corresponding frame regions in the first image I1 and the second image I2, respectively.

If the first image I1 is divided into four frame regions Frame_1, Frame_2, Frame_3 and Frame_n, the scan image generating unit 200 may generate scan images separately for the frame regions Frame_1, Frame_2, Frame_3 and Frame_n. In this case, the second image I2 may be divided into four frame regions Frame_1′, Frame_2′, Frame_3′ and Frame_n′ and scanned.

In one embodiment, based on the operations of the scan image generating unit 200 and the image processing unit 300, the scan image generating unit 200 may scan the entire area of the reticle 100 corresponding to the first image I1 at one time. After the pellicle 160 is mounted on the reticle 100, the scan image generating unit 200 may scan the entire area of the reticle 100 corresponding to the second image I2 at one time. Then, the image processing unit 300 may detect a defect (e.g., particles) by comparing the entire first image I1 and the entire second image I2 at the same time.

In another embodiment, based on the operations of the scan image generating unit 200 and the image processing unit 300, the scan image generating unit 200 may scan the entire area of the reticle 100 corresponding to the first image I1 at one time. After the pellicle 160 is mounted on the reticle 100, the scan image generating unit 200 may scan the entire area of the reticle 100 corresponding to the second image I2 at one time. Then, the image processing unit 300 may detect one or more defects (e.g., particles) by comparing the image of the first frame region Frame_1 for the first image I1 with the image of the first frame region Frame_1′ for the second image I2, and then comparing the image of the second frame region Frame_2 for the first image I1 with the image of the second frame region Frame_2′ for the second image I2.

In another embodiment, based on the operations of the scan image generating unit 200 and the image processing unit 300, the scan image generating unit 200 may scan the area of the reticle 100 corresponding to the first frame region Frame_1 of the first image I1. After the pellicle 160 is mounted on the reticle 100, the scan image generating unit 200 may scan the area of the reticle 100 corresponding to the first frame region Frame_1′ of the second image I2. The image corresponding to the first frame region Frame_1 of the first image I1 and the image corresponding to the first frame region Frame_1′ of the second image I2 may be provided to the image processing unit 300. The image processing unit 300 may detect one or more defects (e.g., particles) on the pellicle 160, or near, adjacent, or on the reticle 100, by comparing the image corresponding to the first frame region Frame_1 of the first image I1 and the image corresponding to the first frame region Frame_1′ of the second image I2.

By repeatedly performing this process, the image processing unit 300 may detect defects (e.g., particles) by comparing the images corresponding to the second to n-th frame regions Frame_2, Frame_{—}3, . . . , Frame_n of the first image I1 with the images corresponding to the second to n-th frame regions Frame_2′, Frame_3′, . . . , Frame_n′ of the second image I2.

The image processing unit 300 may detect defects (e.g., particles) by comparing the brightness values of the corresponding images between the first to n-th frame regions Frame_1, Frame_2, Frame_{—}3, . . . , Frame_n of the first image I1 and the first to n-th frame regions Frame_1′, Frame_2′, Frame_3′, . . . , Frame_n′ of the second image I2.

FIG. 6 illustrates an example where the image processing unit 300 determines whether there is a defect (e.g., particle) based on a difference value between the first signal S1 and the second signal S2 in a case where particles are generated. If the difference value between the first signal S1 and the second signal S2 is equal to or greater than a predetermined difference value S_TH, the image processing unit 300 determines that a defect (e.g., particle) has occurred at a position P1.

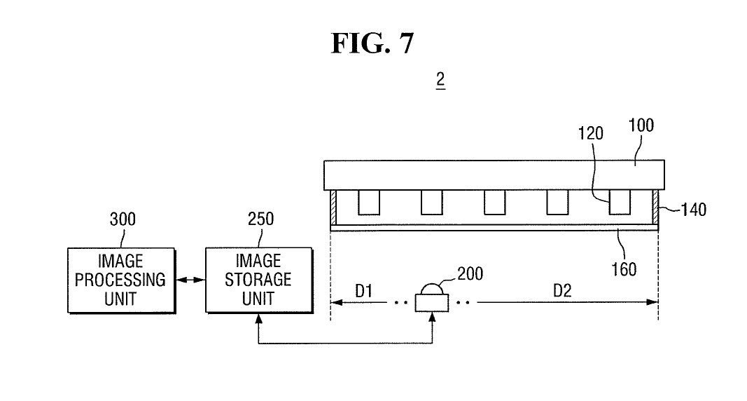

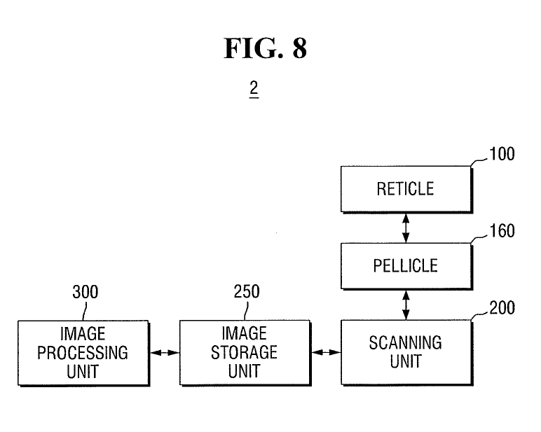

FIG. 7 illustrates another embodiment of a reticle inspection apparatus 2, and FIG. 8 illustrates a block diagram of the reticle inspection apparatus 2. Referring to FIGS. 7 and 8, the reticle inspection apparatus 2 includes the reticle 100, the pellicle 160, the scan image generating unit 200, an image storage unit 250, and the image processing unit 300. The reticle 100, the pellicle 160, the scan image generating unit 200 and the image processing unit 300 may be the same or similar to previous embodiments.

In this embodiment, the scan image generating unit 200 generates the first image I1 and the second image I2 by scanning the surface of the reticle 100 and provides the first image I1 and the second image I2 to the image storage unit 250.

The image processing unit 300 compares the first image I1 and the second image I2 output from the image storage unit 250.

The image storage unit 250 stores the first image I1 and the second image I2 generated by the scan image generating unit 200. Then, the stored first image I1 and second image I2 are provided to the image processing unit 300.

The scan image generating unit 200 may provide only the first image I1 to the image storage unit 250, and the image storage unit 250 may provide the stored first image I1 to the image processing unit 300. Then, the second image I2 generated by the scan image generating unit 200 may be provided to the image processing unit 300 without being provided to the image storage unit 250, and the image processing unit 300 may detect defects (e.g., particles) on the pellicle 160, or near, adjacent, or on the reticle 100, by comparing the first image I1 provided from the image storage unit 250 with the second image I2 provided from the scan image generating unit 200. The image processing unit 300 compares the images of the corresponding frame regions of the first image I1 and the second image I2 in the same way as described above.

When a defect is determined to exist, the pellicle 160 may be clean and put back on the reticle or replaced with a new pellicle, or the defect may otherwise be corrected or removed or the reticle 100 replaced, e.g., when the defect is near, adjacent, or on the reticle 100.

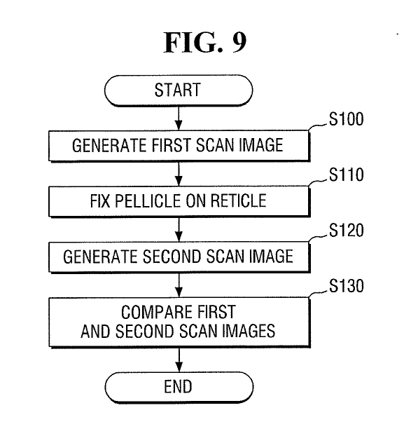

FIG. 9 illustrates an embodiment of a method for inspecting a reticle. Referring to FIG. 9, the method initially includes generating a first scan image SI_1 for the surface of the reticle 100 (S100). The first scan image SI_1 is a scanned image in a state where the pellicle 160 is not fixed on the reticle 100. The first scan image SI_1 may be a scan image for the entire surface of the reticle 100 or may be a scan image for part of the surface of the reticle 100. The first scan image SI_1 may be a scan image obtained, for example, by dividing the entire surface of the reticle 100 into frame regions and then scanning each frame region.

Subsequently, the pellicle 160 is fixed on the reticle 100 (S110). The pellicle 160 is a protective film formed over or coupled to (e.g., stuck to) the surface of the pattern of the reticle 100 in order to prevent contamination of the pattern 120 formed on the reticle 100, e.g., to prevent foreign substances, particles, scratches, or other aberrations on the reticle 100.

Then, a second scan image SI_2 for the surface of the reticle 100 is generated (S120). The second scan image SI_2 is a scanned image in a state where the pellicle 160 is fixed on the reticle 100. The second scan image SI_2 may be a scan image for the entire surface of the reticle 100 or may be a scan image for part of the surface of the reticle 100. The second scan image SI_2 may be a scan image obtained, for example, by dividing the entire surface of the reticle 100 into frame regions and then scanning each frame region.

Subsequently, the first scan image SI_1 is compared with the second scan image SI_2 (S130). Comparing the first scan image SU and the second scan image SI_2 may include or involve comparing the first signal S1 detected from the first scan image SI_1 and the second signal S2 detected from the second scan image SI_2. Each of the first signal S1 and the second signal S2 may be a signal indicative of the brightness value of its respective image. If a difference value between the first signal S1 and the second signal S2 is equal to or greater than a predetermined difference value, defect (e.g., particle) may be determined to exist.

When such a defect is determined to exist, the pellicle 160 may be clean and put back on the reticle or replaced with a new pellicle, or the defect may otherwise be corrected or removed or the reticle 100 replaced, e.g., when the defect is near, adjacent, or on the reticle 100.

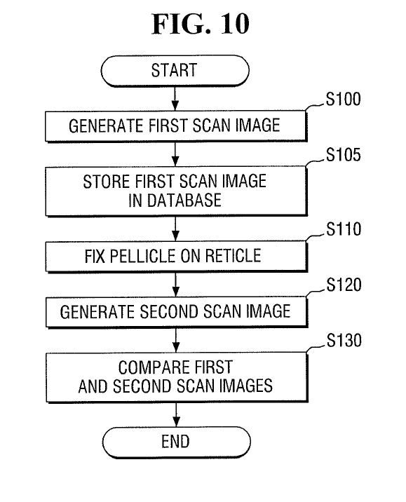

FIG. 10 illustrates another embodiment of a reticle inspection method. Referring to FIG. 10, this method initially includes generating the first scan image SI_1 for the surface of the reticle 100 (S100). Subsequently, the first scan image SI_1 is stored in a database DB or other memory or storage device (S105). Then, the pellicle 160 is fixed on the reticle 100 (S110), and the second scan image SI_2 for the surface of the reticle 100 on which the pellicle 160 is fixed is generated (S120). The first scan image SI_1 is then compared with the second scan image SI_2 (S130). Comparing the first scan image SI_1 and the second scan image SI_2 may involve or include comparing the second scan image SI_2 with the first scan image SI_1 stored in the database DB.

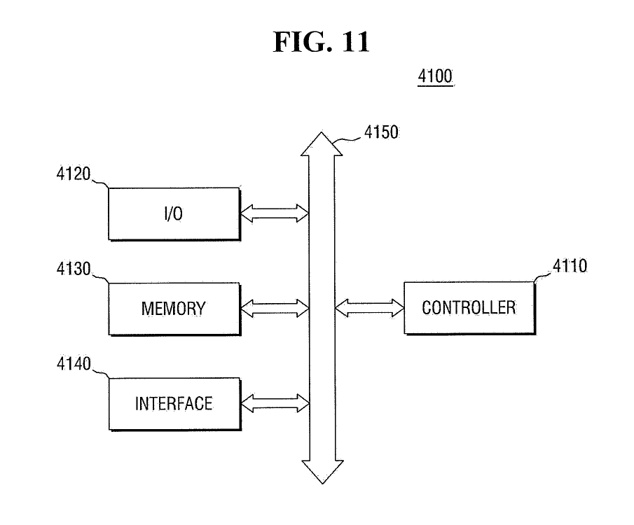

FIG. 11 illustrates an electronic system 4100 including a semiconductor device formed by any of the aforementioned embodiments of the reticle inspection apparatus. Referring to FIG. 11, the electronic system 4100 includes a controller 4110, an input/output (I/O) device 4120, a memory device 4130, an interface 4140, and a bus 4150. The controller 4110, the I/O device 4120, the memory device 4130, and/or the interface 4140 may be coupled to each other through the bus 4150. The bus 4150 corresponds to a path through which data are transferred.

The controller 4110 may include at least one of a micro-processor, a digital signal processor, a micro-controller and other logic devices capable of performing functions similar to those thereof. The I/O device 4120 may include a keypad, a keyboard, a display device, etc. The memory device 4130 stores data and/or commands.

The interface 4140 serves to transmit/receive data to/from a communication network. The interface 4140 may be of a wired or wireless type. For example, the interface 4140 may include, for example, an antenna or a wired/wireless transceiver.

The electronic system 4100 may include a high-speed DRAM and/or SRAM as an operating memory for improving the operation of the electronic system 4100. The semiconductor device formed according to the aforementioned embodiments may be or included in the memory device 4130, the controller 4110, and/or the I/O device 4120.

The electronic system 4100 may be, for example, a personal digital assistant (PDA), a portable computer, a web tablet, a wireless phone, a mobile phone, a digital music player, a memory card, or any electronic product capable of transmitting and/or receiving information in a wireless environment.

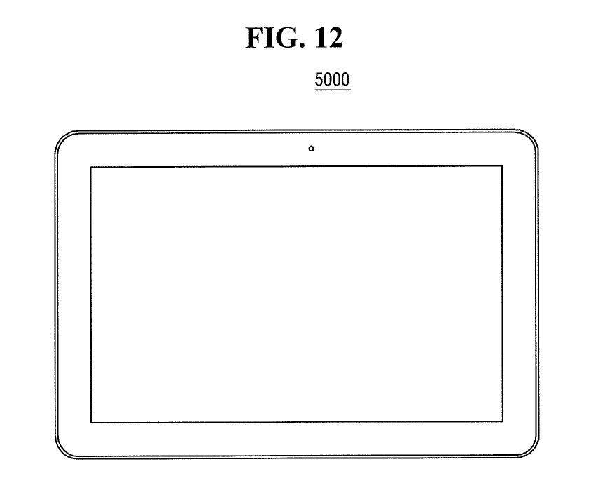

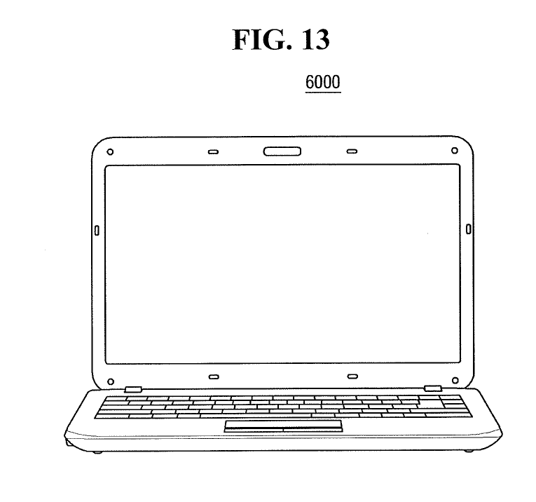

FIGS. 12 and 13 show examples of semiconductor systems including a semiconductor device according to any of the aforementioned embodiments. FIG. 12 illustrates an example of a tablet PC 5000 and FIG. 13 illustrates an example of a laptop computer 6000. In other embodiments, a semiconductor device may be included in other types of integrated circuit devices.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other processing device into a special-purpose processor for performing the methods described herein.

The processing features of the embodiments disclosed herein may be implemented in logic which, for example, may include hardware, software, or both. When implemented at least partially in hardware, the processing features may be, for example, any one of a variety of integrated circuits including but not limited to an application-specific integrated circuit, field-programmable gate array, combination of logic gates, system-on-chip, microprocessor, or other type of processing/control circuit.

When implemented in at least partially in software, the processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

In accordance with one embodiment, an apparatus includes an interface coupled to an image generator and logic coupled to the interface to determine existence of a defect on a pellicle, or near, adjacent, or on the reticle 100, based on a first signal and a second signal, the first signal corresponding to a first image and the second signal corresponding to a second image, the first image to be generated when the pellicle is not on the reticle and the second image to be generated when the pellicle is on the reticle.

The image generator may be a camera, image scanning unit, or other image capturing or generating device. For example, the image generator may be scanning unit 200 in one or more of the aforementioned embodiments.

The interface may take various forms. For example, the interface may be one or more output terminals, leads, wires, integrated circuit ports, signal lines, or another type of interface of or within a chip including the logic or coupled to the logic. In one example embodiment, the interface may correspond to a signal line between the scanning unit 200 and image processing unit 300, which, for example, may correspond to or include the logic, in FIGS. 3, 7, and 8 or the bus 4150 in FIG. 11. The signal line may or may not be coupled to the image storage unit 250

The logic may perform operations of the image processing units in accordance with one or more of the aforementioned embodiments. The first signal may be indicative of a brightness of the first image, and the second signal may be indicative of a brightness of the second image. The first signal may be indicative of the brightness of one or more partial regions of the first image, and the second signal may be indicative of the brightness of one or more partial regions of the second image. The logic may compare the first signal and the second signal, and determine existence of the defect based on a result of the comparison. The logic may determine existence of the defect when a difference value between the first signal and the second signal is equal to or greater than a predetermined difference value.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A reticle inspection apparatus, comprising:
a reticle;
an image generator to generate images of a surface of the reticle; and
an image processor to compare first and second images generated by the image generator, wherein the first image is to be generated when a pellicle is not on the reticle and the second image is to be generated when the pellicle is on the reticle.

2. The apparatus as claimed in claim 1, further comprising:
an storage area to store one or more of the first or second images.

3. The apparatus as claimed in claim 2, wherein the storage area is to store the first and second images and is to output the first and second images to the image processor.

4. The apparatus as claimed in claim 1, wherein each of the first and second images includes first to n-th frame regions, where n is a natural number equal to or greater than 2.

5. The apparatus as claimed in claim 4, wherein the image processor is to compare images of corresponding ones of the frame regions of the first and second images.

6. The apparatus as claimed in claim 5, wherein the image processor is to compare brightness values of the images of corresponding ones of the frame regions in the first and second images.

7. The apparatus as claimed in claim 1, wherein the image processor is to compare a first signal detected from the first image and a second signal detected from the second image.

8. The apparatus as claimed in claim 7, wherein:
the first signal is indicative of a brightness of at least one frame region of the first image, and
the second signal is indicative of a brightness of at least one frame region of the second image.

9. The apparatus as claimed in claim 8, wherein:
when a difference value between the first signal and the second signal is equal to or greater than a predetermined difference value, the image processor is to determine existence of a defect on the pellicle or adjacent or on the reticle.

10. A reticle inspection apparatus, comprising:
a reticle;
a pellicle on the reticle to transmit extreme ultraviolet (EUV) light;
an image generator to generate first and second images of a surface of the reticle;
a storage area to store the first and second images; and
an image processor to compare the first and second images, wherein the first image is to be generated when the pellicle is not on the reticle and the second image is to be generated when the pellicle is on the reticle.

11. The apparatus as claimed in claim 10, wherein each of the first and second images includes first to n-th frame regions, where n is a natural number equal to or greater than 2.

12. The apparatus as claimed in claim 11, wherein the image processor is to compare images of corresponding ones of the frame regions in the first and second images.

13. The apparatus as claimed in claim 10, wherein the image processor is to compare a first signal detected from the first image and a second signal detected from the second image.

14. The apparatus as claimed in claim 13, wherein:
the first signal is indicative of a brightness of at least one region of the first image, and
the second signal is indicative of a brightness of at least one frame region of the second image.

15. The apparatus as claimed in claim 14, wherein:
when a difference value between the first signal and the second signal is equal to or greater than a predetermined difference value, the image processor is to determine the existence of a defect on the pellicle or adjacent or on the reticle.

16. An apparatus, comprising:
an interface coupled to an image generator; and
logic coupled to the interface to determine existence of a defect on a pellicle or adjacent or on a reticle based on a first signal and a second signal, the first signal corresponding to a first image and the second signal corresponding to a second image, the first image to be generated when the pellicle is not on the reticle and the second image to be generated when the pellicle is on the reticle.

17. The apparatus as claimed in claim 16, wherein:
the first signal is indicative of a brightness of the first image, and
the second signal is indicative of a brightness of the second image.

18. The apparatus as claimed in claim 17, wherein:
the first signal is indicative of the brightness of one or more partial regions of the first image, and
the second signal is indicative of the brightness of one or more partial regions of the second image.

19. The apparatus as claimed in claim 16, wherein the logic is to:
compare the first signal and the second signal, and
determine existence of the defect based on a result of the comparison.

20. The apparatus as claimed in claim 19, wherein the logic is to determine existence of the defect when a difference value between the first signal and the second signal is equal to or greater than a predetermined difference value.
